(19) United States
(12) Patent Application Publication
(10) Pub. No.: US 2025/0317864 A1
(43) Pub. Date: Oct. 9, 2025

(54) BATTERY RELAXATION WITH NON-CONFORMING BLUETOOTH® COMMUNICATION BEHAVIOR

(71) Applicant: Roche Diabetes Care, Inc., Indianapolis, IN (US)

(72) Inventor: Felix Bootz, Speyer (DE)

(21) Appl. No.: 19/243,975

(22) Filed: Jun. 20, 2025

Related U.S. Application Data
(63) Continuation of application No. PCT/US2023/084491, filed on Dec. 18, 2023.

(30) Foreign Application Priority Data
Dec. 20, 2022 (WO) PCT/US2022/082005

(51) Int. Cl. H04W 52/02; G06F 1/3212; H04W 4/80; H04W 48/16; H04W 76/14

(52) U.S. Cl. CPC H04W 52/0261; G06F 1/3212; H04W 4/80; H04W 48/16; H04W 76/14

(57) ABSTRACT

A computer implemented method for conserving power during BLUETOOTH® communication performed by a BLUETOOTH® enabled peripheral computing device, the method comprising advertising availability of the BLUETOOTH® enabled peripheral computing device for pairing, receiving a scan request from a BLUETOOTH® enabled central computing device. transmitting a scan response to the BLUETOOTH® enabled central computing device in response to the scan request, establishing a connection with the BLUETOOTH® enabled central computing device, monitoring a power consumption indicator of the peripheral computing device, introducing a delay period to a response period to a connection event received from the central computing device if the monitored power consumption indicator meets at least one predefined criteria, and wherein the delayed response period causes the response to occur after a predetermined peripheral latency period but prior to a supervision timeout.

### CLAIM OF PRIORITY

This application is a continuation of PCT/US2023/084491 (filed on Dec. 18, 2023), which claims priority to and benefit of PCT/US2022/082005 (filed on Dec. 20, 2022). The contents of these applications are incorporated herein by reference in their entirety.

### TECHNICAL FIELD

The present disclosure relates generally to the art of BLUETOOTH® enabled computing systems, and more specifically to a method of energy conservation during BLUETOOTH® communication using a non-conforming communication behavior.

### BACKGROUND

BLUETOOTH® wireless technology (BWT) is used to establish wireless connectivity between computing devices. (BLUETOOTH® is a registered trademark of BLUETOOTH® SIG, Inc., Kirkland, Wash.) BLUETOOTH® enables such devices to connect and communicate with one another efficiently.

BWT utilizes the free and globally available 2.4 GHz radio band. This band is also known as the industrial, scientific, and medical (ISM) radio band. Operation in the ISM band allows BWT to utilize low levels of power while allowing BLUETOOTH® enabled devices within an acceptable range to share data. Each BLUETOOTH® enabled device may simultaneously communicate with many other devices in a variety of topologies supported by the BLUETOOTH® protocol. BWT is used with a variety of products including mobile computing devices, stationary computing devices, computing peripheral devices, smart phones, wearable computing devices, medical computing devices, and vehicular computing devices.

In order for two BLUETOOTH® enabled devices to communicate with one another, the devices must be “paired” to one another. Such pairing is crucial to BLUETOOTH® communication because it helps to assure that BLUETOOTH® enabled devices only communicate with known or approved BLUETOOTH® enabled devices.

In low energy systems, such as those that use BLUETOOTH® communications, the batteries or power supply in general have a very limited capacity. Batteries in these systems are often taxed by having to supply a continuous power supply, and need relaxation time to recover. Without sufficient relaxation time the battery will crash and the system would go into a brown-out state and become unusable.

### SUMMARY OF THE DISCLOSURE

It is the object of this disclosure to overcome the challenges of untimely energy consumption by BLUETOOTH® enabled devices by providing a non-conforming mechanism for communication. The disclosure addresses this difficulty in the following manner.

In one aspect, a method is provided for conserving power during BLUETOOTH® communication performed by a BLUETOOTH® enabled peripheral computing device. The method includes a) advertising availability of the BLUETOOTH® enabled peripheral computing device for pairing, b) receiving a scan request from a BLUETOOTH® enabled central computing device, c) transmitting a scan response to the BLUETOOTH® enabled central computing device in response to the scan request, d) establishing a connection with the BLUETOOTH® enabled central computing device, e) monitoring a power consumption indicator of the peripheral computing device, and f) introducing a delay period to the response period to a connection event received from the central computing device if the monitored power consumption indicator meets at least one predefined criteria, wherein the delayed response period causes the response to occur after the predetermined peripheral latency period but prior to the supervision timeout.

In another aspect, a BLUETOOTH® enabled peripheral computing device is provided for decreased power consumption during BLUETOOTH® communication. The peripheral computing device includes a processor, a memory and a transceiver. The processor is configured to a) advertise availability of the BLUETOOTH® enabled peripheral computing device for pairing, b) receive a scan request from a BLUETOOTH® enabled central computing device, c) transmit a scan response to the BLUETOOTH® enabled central computing device in response to the scan request, d) establish a connection with the BLUETOOTH® enabled central computing device, f) monitor a power consumption level of the peripheral computing device, and g) delay the response period to a connection event received from the central computing device if the monitored power consumption level rises above a predefined threshold, wherein the delayed response period is longer than the predetermined peripheral latency but prior to the supervision timeout.

### BRIEF DESCRIPTION OF THE FIGURES

FIG. 1 illustrates an exemplary configuration of a BLUETOOTH® enabled computing device as described herein.

FIG. 2 is a flowchart representing the steps performed by the BLUETOOTH® enabled computing device of FIG. 1 to perform the affirmation of the pairing between devices.

FIGS. 3A-F illustrate schematic representations of the connection intervals and the effect of the delayed response period according to at least one embodiment of the present disclosure.

FIG. 4 illustrates an exemplary configuration of a system for conserving power during communication of BLUETOOTH® enabled devices, according to at least one embodiment of the present disclosure.

FIG. 5 is a diagram of elements of one or more example computing devices that may be used in the method shown in FIG. 2.

### DETAILED DESCRIPTION

Described herein are methods, a system, and a device for regulating power consumption during communication of BLUETOOTH® enabled devices using a non-conforming communication method to allow for greater periods of battery relaxation. As a result, the methods, system, and device enable the communication of BLUETOOTH® enabled devices with prolonged battery life.

As used herein, the term “central” or “central device” may be used to refer to a BLUETOOTH® enabled device that initiates pairing with a second BLUETOOTH® enabled device that may be referred to as a “peripheral” or a “peripheral device”. As such, a central device is synonymous with a local device and a peripheral device is synonymous with a remote device.

In general, BLUETOOTH® communications can be a significant drain to the power source of the peripheral device. While BLUETOOTH® Low Energy (BLE) is designed as a low power technology, systems that use BLE may also feature very limited power sources. Furthermore, since BLE systems prioritize reliability, frequent transmissions and acknowledgements are used. These frequent communications tax the battery they do not allow for much relaxation time for the battery to recover. Failing to enter a relaxation state periodically may cause the battery to crash where the system would go into a brown-out state and be unusable.

As part of the process to maintain reliable communications between the central and peripheral devices, the central device sends periodic connection events to the peripheral device and the peripheral device responds with an acknowledgement. If the peripheral device does not respond to the connection event before a set time period (the “supervision timeout period”), the communication is terminated. Because of the regular back and forth communication between the central and peripheral device to maintain the BLE pairing, there is a consistent power drain from the battery, which can negatively impact the lifespan of the battery.

The present disclosure addresses the problems caused by the energy expenditure required to maintain BLE connectivity between the central and peripheral devices and the detrimental effect on the lifespan of the power source. Specifically, the present disclosure describes the use of a non-conforming method of communication so that the battery of the peripheral device can spend more time in a relaxation state and in-turn extend its lifespan.

In an exemplary embodiment, a BLUETOOTH® enabled peripheral device is set to pairing mode. The BLUETOOTH® enabled peripheral device further advertises in discoverable mode. The BLUETOOTH® enabled peripheral device may advertise in either a limited discoverable or a general discoverable mode. In the example embodiment, the BLUETOOTH® enabled peripheral device is configured to advertise its general availability for pairing with other devices, specifically with BLUETOOTH® enabled central devices. In at least one embodiment, the BLUETOOTH® enabled peripheral device advertises its availability.

In parallel, at least one BLUETOOTH® enabled central device is configured to discover devices and enters a scanning mode. The BLUETOOTH® enabled central device detects the BLUETOOTH® enabled peripheral device based on the receipt of advertising packets. In response to the advertisement of availability, the BLUETOOTH® enabled central device transmits a scan request to the BLUETOOTH® enabled peripheral device. The BLUETOOTH® enabled peripheral device responds to the scan request with a scan response sent to the BLUETOOTH® enabled central device. Based on an automated or user selection, the BLUETOOTH® enabled central device selects the BLUETOOTH® enabled peripheral device from a list of “discovered devices” if multiple devices have been discovered. Upon such selection, the BLUETOOTH® enabled central device selects the BLUETOOTH® enabled peripheral device for connection and transmits a connection request to the BLUETOOTH® enabled peripheral device. Upon receiving and accepting the connection request, the BLUETOOTH® enabled peripheral device and the BLUETOOTH® enabled central device establish a connection.

Included in the connection request packet from the central device are the connection parameters, such as the connection interval and the peripheral latency value. The connection interval specifies the time between connection events from the central device. Typically, the connection interval ranges from 7.5 ms to 4 seconds. The peripheral latency specifics how many connection events the peripheral device can skip prior to a required response. An additional time period defined as the “supervision time-out” controls for the allowed time between successful connection events. The supervision timeout is coded in at least one example at 20 seconds. If the peripheral device does not respond to the connection event prior to the supervision time-out, the central device terminates the connection and returns to being an unconnected device.

Under the GAP protocol in BLUETOOTH® communication, the connection parameters can only be changed by the peripheral device through requesting the change to the central device, which then decides whether or not to accept the change. In at least one embodiment of the present disclosure, the peripheral device introduces an additional delay time period to postpone the response to the connection event. In at least one embodiment, the introduction of a delay time period is made independent of input from the central device. Inclusion of the delay time causes the peripheral device to respond after the peripheral latency period. The trigger for inclusion of the delay time in at least one embodiment is based on monitoring a power consumption indicator of the peripheral device and determining whether the indicator meets at least one predefined criteria. Such a power consumption indicator can give an indication of the relative health of the power supply and/or whether a significant drain on the power supply is in process or is scheduled to occur.

A technical effect of the systems, methods, and computing devices described herein is to enable the regulation of power during BLUETOOTH® communication of two BLUETOOTH® enabled computing devices when a power indicator meets a threshold criteria. The described embodiments accordingly improve the technical field of BLUETOOTH® networking and wireless networking generally by providing improved communication capabilities by reducing the hazard of power loss due to battery failure.

A technical effect of the systems and methods described herein is achieved by performing at least one of the following steps: (a) advertising availability of the BLUETOOTH® enabled peripheral computing device for pairing; (b) receiving a scan request from a BLUETOOTH® enabled central computing device; (c) transmitting a scan response to the BLUETOOTH® enabled central computing device in response to the scan request; (d) establishing a connection with the BLUETOOTH® enabled central computing device; (c) monitoring a power consumption indicator of the peripheral computing device; (f) introducing a delay period to the timing of the response to a connection event received from the central computing device if the monitored power consumption indicator meets at least one predefined criteria; wherein the delay period causes the response to occur after the predetermined peripheral latency period but prior to the supervision timeout; (g) removing the delay period of the timing of response if the monitored power consumption indicator stops meeting the predefined criteria, if the peripheral computing device detects an analyte reading within a critical range, or if the peripheral computing device detects a sensor malfunction.

As used herein, the term “processor” refers to central processing units, microprocessors, microcontrollers, reduced instruction set circuits (RISC), application specific integrated circuits (ASIC), logic circuits, and any other circuit or processor capable of executing the functions described herein.

Before describing in detail embodiments that are in accordance with the present disclosure, it should be observed that the embodiments reside primarily in combinations of method steps, system elements, and device components related to pairing BLUETOOTH® enabled computing devices. Accordingly, the device components, system elements, and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this document, relative relational terms such as first and second, top and bottom, and the like may be used solely to distinguish one entity or action from another entity or action without necessarily requiring or implying any actual such relationship or order between such entities or actions.

The terms “comprises,” “comprising,” or any other variation thereof, are intended to cover a non-exclusive inclusion, such that a process, method, article, or device that comprises a list of elements does not include only those elements, but may include other elements not expressly listed or inherent to such process, method, article, or device. An element proceeded by “comprises a” does not, without more constraints, preclude the existence of additional identical elements in the process, method, article, or device that comprises the element.

It will be appreciated that embodiments of the disclosure described herein may be comprised of one or more conventional processors and unique stored program instructions that control the one or more processors to implement, in conjunction with certain non-processor circuits, some, most, or all of the functions of preparing a mobile communications device for pairing with a BLUETOOTH® device described herein. The non-processor circuits may include, but are not limited to, a radio receiver, a radio transmitter, signal drivers, clock circuits, power source circuits, and user input devices. As such, these functions may be interpreted as steps of a method to perform preparing a BLUETOOTH® enabled computing device for pairing with another BLUETOOTH® enabled device. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

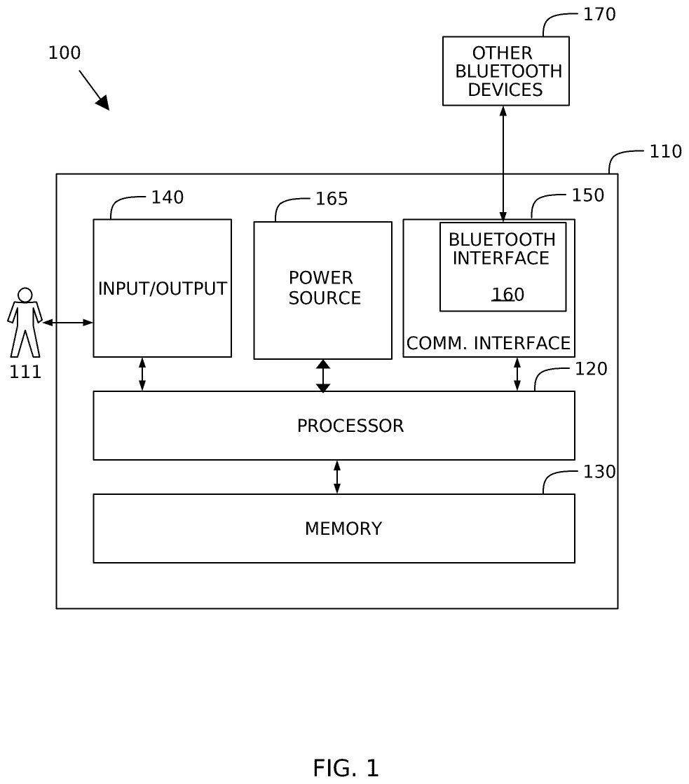

FIG. 1 illustrates an exemplary configuration 100 of a BLUETOOTH® enabled computing device. Specifically, FIG. 1 illustrates an exemplary configuration 100 of a BLUETOOTH® enabled computing device 110 operated by a user 111 in accordance with at least one embodiment of the present disclosure. BLUETOOTH® enabled computing device 110 may include, but is not limited to, mobile computing devices, stationary computing devices, computing peripheral devices, smart phones, wearable computing devices, medical computing devices, and vehicular computing devices. Alternatively, BLUETOOTH® enabled computing device 110 may be any computing device capable of BLUETOOTH® pairing described herein. In some variations, the characteristics of the described components may be more or less advanced, primitive, or non-functional. Further, BLUETOOTH® enabled computing device 110 in at least one embodiment may be a medical, fitness or lifestyle device with an analyte sensor, such as for example a glucose sensor.

In the exemplary embodiment, BLUETOOTH® enabled computing device 110 includes a processor 120 for executing instructions. In some embodiments, executable instructions are stored in a memory area 130. Processor 120 may include one or more processing units, for example, a multi-core configuration. Memory area 130 is any device allowing information such as executable instructions and/or written works to be stored and retrieved. Memory area 130 may include one or more computer readable media.

BLUETOOTH® enabled computing device 110 may also include at least one input/output component 140 for receiving information from and providing information to user 111. In some examples, input/output component 140 may be of limited functionality or non-functional as in the case of some wearable computing devices. In other examples, input/output component 140 is any component capable of conveying information to or receiving information from user 111. In some embodiments, input/output component 140 includes an output adapter such as a video adapter and/or an audio adapter. Input/output component 140 may alternatively include an output device such as a display device, a liquid crystal display (LCD), organic light emitting diode (OLED) display, or “electronic ink” display, or an audio output device, a speaker or headphones. Input/output component 140 may also include any devices, modules, or structures for receiving input from user 111. Input/output component 140 may therefore include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output and input device of input/output component 140. Input/output component 140 may further include multiple sub-components for carrying out input and output functions.

BLUETOOTH® enabled computing device 110 may also include a communications interface 150, which may be communicatively coupleable to a remote device such as a remote computing device, a remote server, or any other suitable system. Communication interface 150 may include, for example, a wired or wireless network adapter or a wireless data transceiver for use with a mobile phone network, Global System for Mobile communications (GSM), 3G, 4G, 5G, or other mobile data network or Worldwide Interoperability for Microwave Access (WIMAX).

Communications interface 150 further includes a BLUETOOTH® transceiver, or BLUETOOTH® interface 160. BLUETOOTH® interface 160 is capable of completing the pairing, bonding, synchronization, and un-pairing steps described herein as well as transmitting communications with other devices. BLUETOOTH® interface 160 may accordingly be used to allow BLUETOOTH® enabled computing device 110 to communicate with any other BLUETOOTH® devices 170.

BLUETOOTH® enabled computing device 110 also includes a power source 165, which provides power to at least one component of computing device 110. In some embodiments, power source 165 is operably coupled to at least one of processor 120, memory area 130, input/output component 140, and communications interface 150. Power source 165 in at least one embodiment can be any power supply that is generally acceptable for the peripheral device. For example, a lithium battery, such as for example a lithium coin battery may be used in at least one embodiment.

Generally, BLUETOOTH®-enabled devices establish connection and communications in the following manner. A first device (“an advertising device”) is placed into pairing mode and advertises its availability via an advertising packet (or a broadcast query). The advertising packet contains a device identifier. Other devices (“scanning devices”) may also be placed into pairing mode and scan for available devices. Scanning devices scan by submitting scan requests. In this example, scan requests detect advertised messages sent via broadcast queries such as the advertising packet sent by the advertising device. (Optionally, the scanning devices may send scan requests directly to advertising devices with which they seek to pair. The advertising devices may respond to the scanning device with a scan response, indicating willingness to pair.) The scanning device then sends a connection request to the advertising device. Advertising devices may accept connection request and create a connection with scanning device. Once a connection is established, a communication channel is opened between the advertising and scanning devices. The scanning device sends a pairing request to the advertising device which responds with a pairing response. The pairing response includes a specific device address. Finally, the scanning device completes pairing using the specific device address. At this point, the scanning device and advertising device have established a pairing that may be used for reconnection. They may continue communications or disconnect with the possibility of later reconnection.

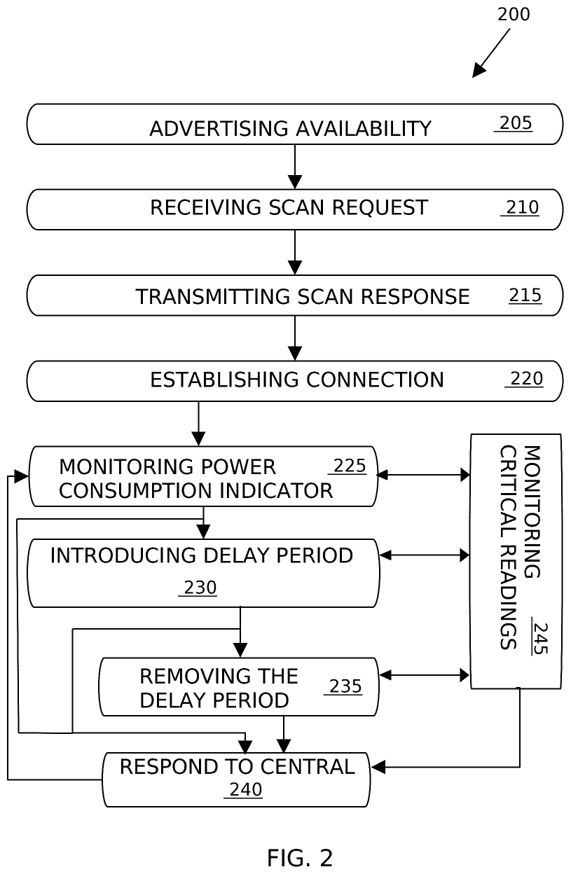

Referring to FIG. 2, a flowchart 200 is shown representing the steps performed by the BLUETOOTH® enabled computing device of FIG. 1 to conserve power during BLUETOOTH® communication between the devices, according to at least one embodiment of the present disclosure. Initially, BLUETOOTH® enabled peripheral device advertises 205 availability for pairing by transmitting advertising data packets. BLUETOOTH® enabled peripheral device may advertise availability for pairing in either a limited or a general mode.

BLUETOOTH® enabled peripheral device receives 210 a scan request from BLUETOOTH® enabled central device and the BLUETOOTH® enabled peripheral device replies 215 with a scan response. Upon receiving the scan response, BLUETOOTH® enabled central device selects the BLUETOOTH® enabled peripheral device from a device list if multiple devices are found in scanning. BLUETOOTH® enabled central device further sends a connection request to the BLUETOOTH® enabled peripheral device to establish 220 a BLUETOOTH® connection. Upon connection, BLUETOOTH® enabled central device performs GATT service discovery and GATT characteristic discovery to learn the characteristics and services available from BLUETOOTH® enabled peripheral device.

BLUETOOTH® enabled peripheral device monitors 225 a power consumption indicator of the peripheral computing device. In at least one embodiment, the power consumption indicator is a measure of the health of the power source or the effect of the activities of the peripheral computing device on its power source. Monitoring 225 a power consumption indicator may in some examples monitor the estimated state of charge or the estimated state of health of the power source in the peripheral computing device. Further, the power consumption indicator may also track the usage of energy intensive procedures. If the monitored power consumption indicator meets at least one predetermined criteria, a delay period is introduced 230 to the timing of the response to the connection event received. The delay period introduced by the peripheral device causes the response to occur after the predetermined latency period but prior to the supervision time-out. In at least one embodiment, the delay period may be one or more connection intervals, or a fraction thereof. For example, the delay period may add the maximum number of connection intervals so that the peripheral device responds to the central device just prior to the supervision time-out. In at least one embodiment, the delay period is only for the next response by the peripheral.

The predefined criteria in at least one embodiment of monitoring 225 tracks the negative impact currently being forced on the power source of the peripheral device, or the relative condition of the power source. The predetermined criteria, in at least one embodiment, may be one or more of at least one energy intensive procedure or exceeding a specified power load within a defined timeframe. The at least one energy intensive procedure may include at least one of read/write data in the flash routine, performing an energy-intensive algorithm, and performing a mass data transfer. The predetermined criteria may also be a preset threshold for the estimated state of charge or the estimated state of health of the power source in the peripheral computing device. Exceeding this threshold would trigger the introduction 230 of the delay period. The preset threshold in at least one embodiment may be modified based on the use of energy intensive procedures by the peripheral.

In at least one embodiment of the method for conserving power, BLUETOOTH® enabled peripheral device removes 235 the delay of the timing of response if a predefined trigger is met. In at least one example, the trigger may be at least one of if the monitored power consumption indicator no longer meets the predefined criteria, if the peripheral computing device detects an analyte reading within a critical range, and if the peripheral computing device detects a sensor malfunction within the peripheral computing device.

In at least one embodiment of the method for conserving power, BLUETOOTH® enabled peripheral device monitors 245 critical readings, such as analyte readings and sensor functions. If an analyte reading is detected within a critical range or if a sensor malfunction is detected, the peripheral device responds 240 to the central device. This response 240 in at least one example may occur immediately despite the peripheral latency or a delay period added to the response period.

For the detection of an analyte reading, an example of a critical range may be a range, or threshold specified by the user's healthcare provider. Additionally, in an embodiment where glucose is the analyte being detected, an example of a critical reading may be one indicating a hypoglycemic or hyperglycemic reading. In at least one embodiment, a hypoglycemic reading may be a glucose reading of 70 mg/dL or below, or 3.9 mmol/L or below. A hypoglycemic reading may in at least one additional embodiment be 65 mg/dL or below, 60 mg/dL or below, 55 mg/dL or below, the respective metric conversion for one of the previous concentrations, or a reading set by the user. A critical reading indicated by a hyperglycemic reading may, in at least one embodiment, be a reading at or above 180 mg/dL, a reading at or above 200 mg/dL, or above a user defined or healthcare provider defined threshold.

In at least one embodiment of the present method, the peripheral device will continuously monitor 225 the power consumption indicator. Such monitoring in at least one example can occur after at least one of the introduction of the delay period, the removal of the delay period, and the monitoring of critical readings 245.

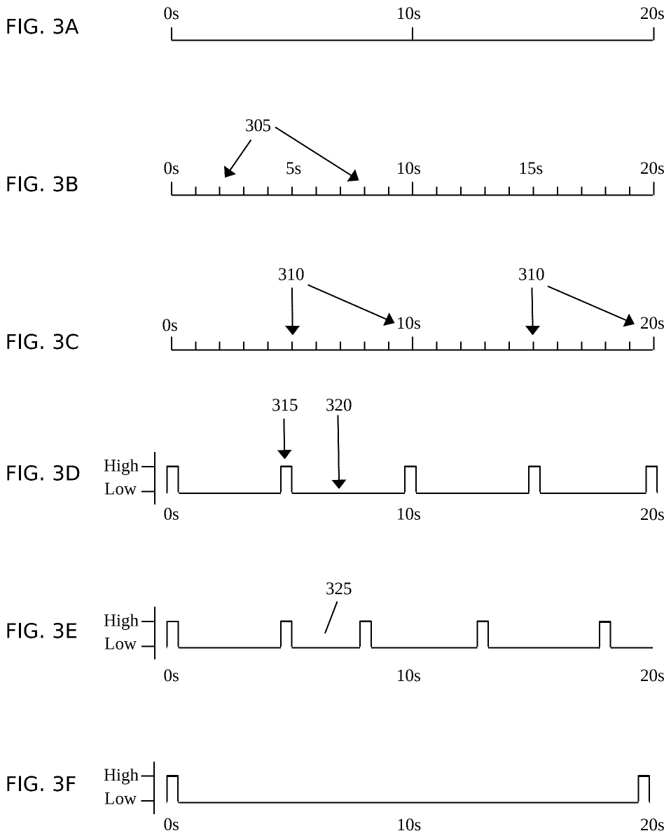

FIGS. 3A-3F illustrate schematic representations of the connection intervals and the effect of the delayed response period according to at least one embodiment of the present disclosure. FIG. 3A illustrates a twenty second communication period between a peripheral device and central device according to at least one embodiment of the disclosure, where the supervisor time-out occurs at the twenty second period if the peripheral device does not respond to the central device. FIG. 3B illustrates an embodiment of FIG. 3A where the connection intervals 305 are one second intervals as is shown by vertical hash marks. FIG. 3C illustrates an embodiment of FIG. 3B where a peripheral latency periods 310 (in this example the peripheral latency periods having a value of five) are every 5 seconds. In this instance the peripheral would respond to the central device every five seconds to maintain the connection. FIG. 3D illustrates the energy expenditure of the peripheral device in the example shown in FIG. 3C, with the Y-axis showing high or low energy expenditures. Each time the peripheral device sends a response to the central device there is a peak 315 in energy expenditure which then returns to a low level 320 following transmission. FIG. 3E illustrates an embodiment of FIG. 3C where a critical condition is detected. In such an example, the peripheral device responds to the central device prior to the slave latency period ending (see shortened response period at 325). An example of a critical condition in such an embodiment may be a critical reading or a sensor malfunction. FIG. 3F illustrates an embodiment of FIG. 3C where the peripheral device has added a delay period to the response period. The energy level in this example remains at a low level until the response by the peripheral just prior to the supervisory time-out where the energy expenditure peaks.

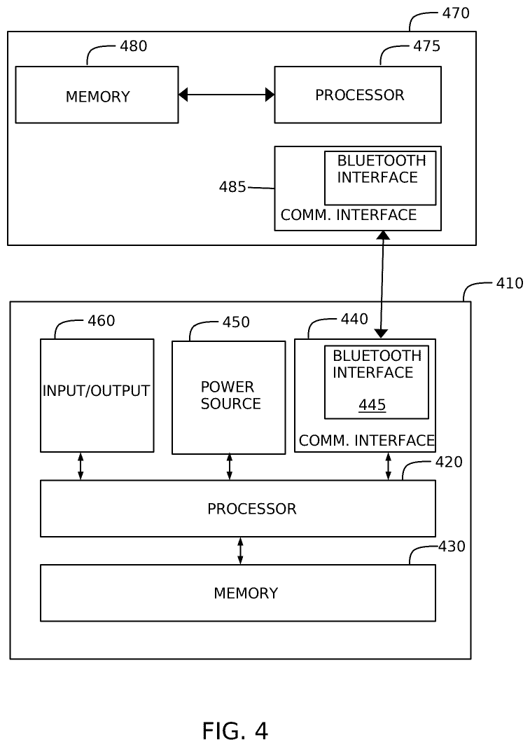

FIG. 4 illustrates an exemplary configuration 400 of a system for conserving power during communication of BLUETOOTH® enabled devices, according to at least one embodiment of the present disclosure. Configuration 400 in at least one embodiment includes BLUETOOTH® enabled peripheral device 410 and BLUETOOTH® enabled central device 470. Peripheral device 410 may be an embodiment of computing device 110. Peripheral device 410 being operable to perform an embodiment of the method of FIG. 2. In at least one embodiment, BLUETOOTH® enabled peripheral device 410 comprises a first processor 420 for executing instructions, first memory 430, first communication interface 440 and a power source 450. Communication interface 440 further comprises a BLUETOOTH® interface 445. In an embodiment, peripheral device 410 may also have an input/output device that is operable for input from a user. In at least one embodiment, BLUETOOTH® enabled central device 470 comprises a second processor 475, a second memory 480 and a second transceiver 485 with a BLUETOOTH® interface.

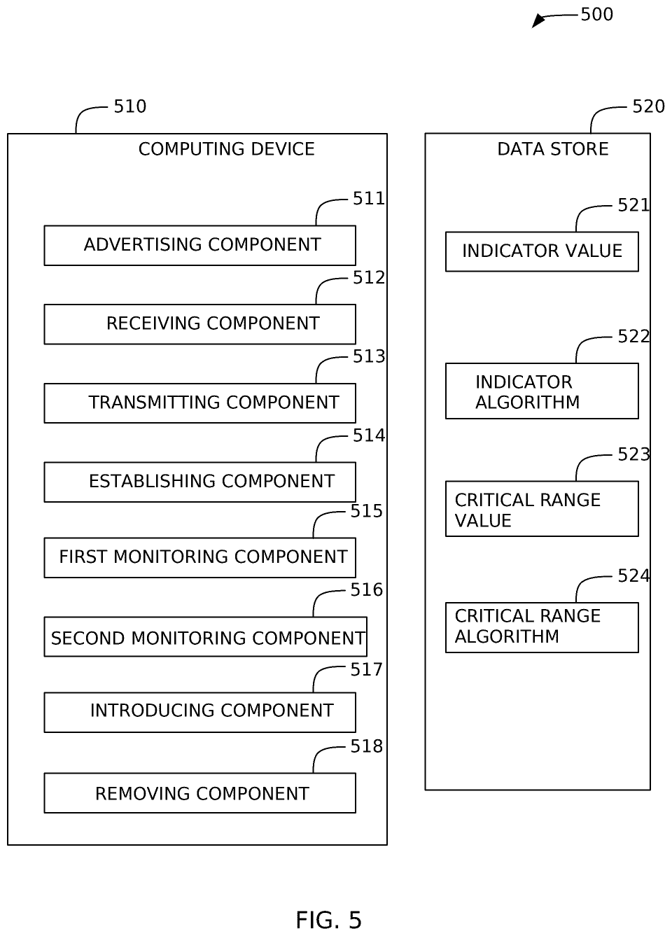

FIG. 5 is a diagram 500 of components of one or more example computing devices that may be used in the method shown in FIG. 2. In some embodiments, computing device 510 is similar to BLUETOOTH® enabled computing device 110.

Data store 520 may be stored at memory 130 (shown in FIG. 1) or any other suitable location. Data store 520 may be coupled with several separate components 511, 512, 513, 514, 515, 516, 517, and 518 within computing device 510, which perform specific tasks.

In this embodiment, data store 520 includes an indicator value 521 for comparison to the monitored power consumption indicator, an indicator algorithm 522, critical range value 523, and critical range algorithm 524.

Computing device 510 also includes an advertising component 511 for advertising availability of the BLUETOOTH® enabled peripheral computing device for pairing, a receiving component 512 for receiving a scan request from a BLUETOOTH® enabled central computing device, a transmitting component 513 for transmitting a scan response to the BLUETOOTH® enabled central computing device in response to the scan request, an establishing component 514 for establishing a connection with to the BLUETOOTH® enabled central computing device, a first monitoring component 515 for monitoring a power consumption indicator of the BLUETOOTH® enabled peripheral computing device, a second monitoring component 516 for monitoring critical readings of the BLUETOOTH® enabled peripheral computing device, an introducing component 517 for introducing a delay period to a response period by the BLUETOOTH® enabled peripheral computing device, a removing component 518 for removing the delay period from the delayed response period of the BLUETOOTH® enabled peripheral computing device.

In at least one embodiment of data store 520, indicator value 521 includes at least one of threshold values for the estimated state of health and/or state of charge for the power source of the computing device 510. Additionally, indicator value 521 may include a list or identifiers for tasks that are considered energy intensive procedures for computing device 510. For example, indicator value 521 may include one or more of a read/write data in the flash routine, performing an energy-intensive algorithm, performing a mass data transfer, and a specified energy load threshold for a set timeframe. Critical value 523, may include at least one of a critical analyte threshold and/or at least one value associated with a sensor malfunction. Indicator algorithm 522 and critical range algorithm 524 each include at least one algorithm for use in comparing measured data from computing device 510 with the respective values stored in indicator value 521 and critical range value 523.

The systems and processes are not limited to the specific embodiments described herein. In addition, components of each system and each process can be practiced independently and separate from other components and processes described herein. Each component and process also can be used in combination with other assembly packages and processes.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure has been described in terms of various specific embodiments, those skilled in the art will recognize that the disclosure can be practiced with modification within the spirit and scope of the claims.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. Example computer-readable media may be, but are not limited to, a flash memory drive, digital versatile disc (DVD), compact disc (CD), fixed (hard) drive, diskette, optical disk, magnetic tape, semiconductor memory such as read-only memory (ROM), and/or any transmitting/receiving medium such as the Internet or other communication network or link. By way of example and not limitation, computer-readable media comprise computer-readable storage media and communication media. Computer-readable storage media are tangible and non-transitory and store information such as computer-readable instructions, data structures, program modules, and other data. Communication media, in contrast, typically embody computer-readable instructions, data structures, program modules, or other data in a transitory modulated signal such as a carrier wave or other transport mechanism and include any information delivery media. Combinations of any of the above are also included in the scope of computer-readable media. The article of manufacture containing the computer code may be made and/or used by executing the code directly from one medium, by copying the code from one medium to another medium, or by transmitting the code over a network.

All of the patents, patent applications, patent application publications and other publications recited herein are hereby incorporated by reference as if set forth in their entirety.

The present inventive concept has been described in connection with what are presently considered to be the most practical and preferred embodiments. However, the inventive concept has been presented by way of illustration and is not intended to be limited to the disclosed embodiments. Accordingly, one of skill in the art will realize that the inventive concept is intended to encompass all modifications and alternative arrangements within the spirit and scope of the inventive concept as set forth in the appended claims. Numbered embodiments are presented below.

### NUMBERED EMBODIMENTS

In addition or as an alternative to the above, the following embodiments are described:

1. A computer implemented method for conserving power during BLUETOOTH® communication performed by a BLUETOOTH® enabled peripheral computing device, the method comprising:
a) advertising availability of the BLUETOOTH® enabled peripheral computing device for pairing;
b) receiving a scan request from a BLUETOOTH® enabled central computing device;
c) transmitting a scan response to the BLUETOOTH® enabled central computing device in response to the scan request;
d) establishing a connection with the BLUETOOTH® enabled central computing device;
e) monitoring a power consumption indicator of the peripheral computing device;
f) introducing a delay period to the response to a connection event received from the central computing device if the monitored power consumption indicator meets at least one predefined criteria; and
wherein the delayed response period causes the response to occur after the predetermined peripheral latency period but prior to the supervision timeout.

2. The method of Embodiment 1, wherein the step of monitoring the power consumption indicator includes monitoring an estimated state of charge or estimated state of health of a power source in the peripheral computing device.

3. The method of at least one previous Embodiment, wherein the predefined criteria includes performing at least one energy intensive procedure or exceeding a specified power load within a defined timeframe.

4. The method of at least one previous Embodiment, wherein the at least one energy intensive procedure includes at least one of read/write data in the flash routine, performing an energy-intensive algorithm, and performing a mass data transfer.

5. The method of at least one previous Embodiment, further comprising the step of removing the delay of the timing of response if the monitored power consumption indicator does not meet the predefined criteria.

6. The method of at least one previous Embodiment, further comprising the step of removing the delay period if the peripheral computing device detects an analyte reading within a critical range.

7. The method of at least one previous Embodiment, further comprising the step of removing the delay period if the peripheral computing device detects a sensor malfunction within the peripheral computing device.

8. The method of at least one previous Embodiment, wherein the BLUETOOTH® enabled peripheral computing device comprises an analyte sensor.

9. A system for conserving power during communication of BLUETOOTH® enabled devices, the system comprising:
a BLUETOOTH® enabled peripheral computing device comprising a first processor, a first memory, and a first transceiver; and
a central BLUETOOTH® enabled computing device comprising a second processor, a second memory, and a second transceiver,
wherein said first processor is configured to:
   a) advertise availability of the BLUETOOTH® enabled peripheral computing device for pairing;
   b) receive a scan request from a BLUETOOTH® enabled central computing device;
   c) transmit a scan response to the BLUETOOTH® enabled central computing device in response to the scan request;
   d) establish a connection with the BLUETOOTH® enabled central computing device;
   e) monitor a power consumption indicator of the peripheral computing device;
   f) delay the response to a connection event received from the central computing device if the monitored power consumption indicator meets at least one predefined criteria; and
   wherein the delayed response occurs after a predetermined peripheral latency but prior to the supervision timeout.

10. The system of Embodiment 9, wherein the predefined criteria includes performing at least one energy intensive procedure or exceeding a specified power load within a defined timeframe.

11. The system of at least one previous Embodiment, wherein the at least one energy intensive procedure includes at least one of read/write data in the flash routine, performing an energy-intensive algorithm, and performing a mass data transfer.

12. The system of at least one previous Embodiment, further comprising the step of removing the delay of the timing of response if the monitored power consumption indicator does not meet the predefined criteria.

13. The system of at least one previous Embodiment, further comprising the step of removing the delay of the timing of response if the peripheral computing device detects an analyte reading within a critical range.

14. A BLUETOOTH® enabled peripheral computing device for decreased power consumption, the computing device comprising:
a processor, a memory and a transceiver, the processor configured to:
   a) advertise availability of the BLUETOOTH® enabled peripheral computing device for pairing;
   b) receive a scan request from a BLUETOOTH® enabled central computing device;
   c) transmit a scan response to the BLUETOOTH® enabled central computing device in response to the scan request;
   d) establish a connection with the BLUETOOTH® enabled central computing device;
   e) monitor a power consumption level of the peripheral computing device;
   f) introduce a delay period to the response period to a connection event received from the central computing device if the monitored power consumption level meets at least one predefined criteria; and
      wherein the delayed response period causes the response to occur after a predetermined peripheral latency but prior to the supervision timeout.

15. The device of at least one previous Embodiment, wherein the step of monitoring the power consumption indicator includes monitoring the estimated state of charge or estimated state of health of the power source in the peripheral computing device.

16. The device of at least one previous Embodiment, wherein the predefined criteria includes at least one of performing at least one energy intensive procedure and exceeding a specified power load within a defined timeframe.

17. The device of at least one previous Embodiment, wherein the at least one energy intensive procedure includes at least one of read/write data in the flash routine, performing an energy-intensive algorithm, and performing a mass data transfer.

18. The device of at least one previous Embodiment, wherein the processor is further configured to perform the step of removing the delay period from the delayed response period if the monitored power consumption indicator does not meet the predefined criteria.

19. The device of at least one previous Embodiment, wherein the processor is further configured to perform the step of removing the delay period from the delayed response period if the peripheral computing device detects an analyte reading within a critical range.

20. The device of at least one previous Embodiment, wherein the processor is further configured to perform the step of removing the delay period from the delayed response period if the peripheral computing device detects a sensor malfunction within the peripheral computing device.

21. The device of at least one previous Embodiment, wherein the BLUETOOTH® enabled peripheral computing device comprises an analyte sensor.

### LISTING OF REFERENCE NUMBERS

100 Configuration
110 BLUETOOTH®-enabled computing device
111 User
120 Processor
130 Memory area
140 Input/output component
150 Communication interface
160 BLUETOOTH® interface
170 Additional BLUETOOTH® devices
200 Flowchart
205 Peripheral advertises in discoverable mode
210 Central device sends scan request
215 Peripheral responds with scan response
220 Central sends connection request to peripheral
225 Peripheral monitoring power consumption indicator
230 Peripheral introducing a delay period
235 Peripheral removes delay period
300 Configuration
305 Connection Interval
310 Peripheral latency period
315 High energy expenditure
320 Low energy expenditure
325 Shortened response time
400 Configuration
410 BLUETOOTH®-enabled peripheral device
420 First processor
430 First memory
440 Communication interface
445 BLUETOOTH® interface
450 Power source
460 Input/Output
470 BLUETOOTH® enabled central device
475 Second processor
480 Second memory
485 Second transceiver
500 Diagram
510 Computing device
511 Advertising component
512 Receiving component
513 Transmitting component
514 Establishing component
515 First monitoring component
516 Second monitoring component
517 Introducing component
518 Removing component
520 Data store
521 Indicator value
522 Indicator algorithm
523 Critical range value
524 Critical range algorithm

What is claimed:

1. A computer implemented method for conserving power during BLUETOOTH® communication performed by a BLUETOOTH® enabled peripheral computing device, the method comprising:
a) advertising availability of the BLUETOOTH® enabled peripheral computing device for pairing;
b) receiving a scan request from a BLUETOOTH® enabled central computing device;
c) transmitting a scan response to the BLUETOOTH® enabled central computing device in response to the scan request;
d) establishing a connection with the BLUETOOTH® enabled central computing device;
e) monitoring a power consumption indicator of the peripheral computing device;
f) introducing a delay period to a response period to a connection event received from the central computing device if the monitored power consumption indicator meets at least one predefined criteria; and
wherein the delayed response period causes the response to occur after a predetermined peripheral latency period but prior to a supervision timeout.

2. The method of claim 1, wherein the step of monitoring the power consumption indicator includes monitoring an estimated state of charge or estimated state of health of a power source in the peripheral computing device.

3. The method of claim 1, wherein the predefined criteria includes performing at least one energy intensive procedure or exceeding a specified power load within a defined timeframe.

4. The method of claim 3, wherein the at least one energy intensive procedure includes at least one of read/write data in the flash routine, performing an energy-intensive algorithm, and performing a mass data transfer.

5. The method of claim 1, further comprising the step of removing the delay period from the delayed response period if the monitored power consumption indicator does not meet the predefined criteria.

6. The method of claim 1, further comprising the step of removing the delay period from the delayed response period if the peripheral computing device detects an analyte reading within a critical range.

7. The method of claim 1, further comprising the step of removing the delay period from the delayed response period if the peripheral computing device detects a sensor malfunction within the peripheral computing device.

8. The method of claim 1, wherein the BLUETOOTH® enabled peripheral computing device comprises an analyte sensor.

9. A BLUETOOTH® enabled peripheral computing device for decreased power consumption, the computing device comprising:
a processor, a memory and a transceiver, the processor configured to:
a) advertise availability of the BLUETOOTH® enabled peripheral computing device for pairing;
b) receive a scan request from a BLUETOOTH® enabled central computing device;
c) transmit a scan response to the BLUETOOTH® enabled central computing device in response to the scan request;
d) establish a connection with the BLUETOOTH® enabled central computing device;
e) monitor a power consumption level of the peripheral computing device;
f) introduce a delay period to a response period to a connection event received from the central computing device if the monitored power consumption level meets at least one predefined criteria; and
wherein the delayed response period causes the response to occur after a predetermined peripheral latency but prior to the supervision timeout.

10. The device of claim 9, wherein the step of monitoring the power consumption indicator includes monitoring the estimated state of charge or estimated state of health of a power source in the peripheral computing device.

11. The device of claim 9, wherein the predefined criteria includes at least one of performing at least one energy intensive procedure and exceeding a specified power load within a defined timeframe.

12. The device of claim 11, wherein the at least one energy intensive procedure includes at least one of read/write data in the flash routine, performing an energy-intensive algorithm, and performing a mass data transfer.

13. The device of claim 9, wherein the processor is further configured to perform the step of removing the delay period from the delayed response period if the monitored power consumption indicator does not meet the predefined criteria.

14. The device of claim 9, wherein the processor is further configured to perform the step of removing the delay period from the delayed response period if the peripheral computing device detects at least one of an analyte reading within a critical range and a sensor malfunction within the peripheral computing device.

15. The device of claim 9, wherein the BLUETOOTH® enabled peripheral computing device comprises an analyte sensor.
